(19) United States
(12) Patent Application Publication
(10) Pub. No.: US 2013/0271388 A1
(43) Pub. Date: Oct. 17, 2013

(54) TOUCH SENSING THREE-DIMENSIONAL DISPLAY DEVICE

(71) Applicants: Bo-Han Chu, New Taipei City (TW); De-Wei Kuo, Taipei City (TW); Jhen-Shen Liao, Taoyuan County (TW); Wen-Che Wang, New Taipei City (TW); Te-Yu Chen, Kaohsiung City (TW); Wen-Chuan Wang, Taoyuan County (TW); Hung-Hsiang Chen, Taoyuan County (TW)

(72) Inventors: Bo-Han Chu, New Taipei City (TW); De-Wei Kuo, Taipei City (TW); Jhen-Shen Liao, Taoyuan County (TW); Wen-Che Wang, New Taipei City (TW); Te-Yu Chen, Kaohsiung City (TW); Wen-Chuan Wang, Taoyuan County (TW); Hung-Hsiang Chen, Taoyuan County (TW)

(73) Assignee: CHUNGHWA PICTURE TUBES, LTD., Taoyuan (TW)

(21) Appl. No.: 13/565,823

(22) Filed: Aug. 3, 2012

(30) Foreign Application Priority Data
Apr. 16, 2012 (TW) 101113479

(51) Int. Cl. G06F 3/041

(52) U.S. Cl. 345/173

(57) ABSTRACT

A touch sensing three-dimensional (3D) display device includes a display panel and a touch sensing parallax integrated panel. The touch sensing parallax integrated panel located on the display panel includes a first substrate, a second substrate, a touch sensing structure, a display medium layer, a first parallax electrode layer, and a second parallax electrode layer. The second substrate is disposed opposite to the first substrate. The first substrate is located between the display panel and the second substrate. The touch sensing structure is located on the second substrate. The display medium layer is disposed between the first substrate and the second substrate. The first parallax electrode layer disposed on the first substrate is located between the display medium layer and the first substrate. The second parallax electrode layer disposed on the second substrate is located between the display medium layer and the second substrate.

### CROSS-REFERENCE TO RELATED APPLICATION

This application claims the priority benefit of Taiwan application serial no. 101113479, filed on Apr. 16, 2012. The entirety of the above-mentioned patent application is hereby incorporated by reference herein and made a part of this specification.

### BACKGROUND OF THE INVENTION

1. Field of the Invention

The invention relates to a display device, and more particularly, to a touch sensing three-dimensional (3D) display device.

2. Description of Related Art

With advancement of display technology and users' demand for multi-functionality of display devices, the conventional display devices that are simply equipped with the display function no longer satisfy users' needs. To provide users with an interactive, user-friendly, easy-to-use, and attractive input interface, facilitate direct use of display devices, and replace additional input devices including keyboards or mice, touch sensing panels are often configured on display panels of the display devices.

Moreover, the existing flat display devices in a normal flat display mode are unable to comply with the requirement for perception of visual realism. Accordingly, 3D display devices have been developed, so that users are allowed to observe stereo images with spatial depth as if they are there. Both the configuration of the touch sensing panel and the application of 3D display technology need be implemented together with the use of a display panel.

At present, integration of the display panel, the touch sensing panel, and the 3D display technology is accomplished by performing an adhesion process twice. For instance, when an auto-stereoscopic display technology is applied to a touch sensing panel, a parallax barrier sheet is adhered to the display panel, and an out-cell touch sensing panel is then attached thereto. Nonetheless, since the adhesion process is performed twice to adhere the parallax barrier sheet, the display panel, and the out-cell touch sensing panel, the overall thickness of the touch sensing 3D display device and the manufacturing costs are apt to increase, and the transmittance of the touch sensing 3D display device is reduced.

### SUMMARY OF THE INVENTION

The invention is directed to a touch sensing 3D display device having relatively low manufacturing costs.

In an embodiment of the invention, a touch sensing 3D display device that includes a display panel and a touch sensing parallax integrated panel is provided. The touch sensing parallax integrated panel is disposed on the display panel. The touch sensing parallax integrated panel includes a first substrate, a second substrate, a touch sensing structure, a display medium layer, a first parallax electrode layer, and a second parallax electrode layer. The second substrate is disposed opposite to the first substrate. The first substrate is located between the display panel and the second substrate. The touch sensing structure is located on the second substrate. The display medium layer is disposed between the first substrate and the second substrate. The first parallax electrode layer is disposed on the first substrate and located between the display medium layer and the first substrate. The second parallax electrode layer is disposed on the second substrate and located between the display medium layer and the second substrate.

According to an embodiment of the invention, the first parallax electrode layer includes a plurality of bar-shaped electrodes that are separated from and parallel to one another, and the second parallax electrode layer includes a complete electrode layer covering the bar-shaped electrodes.

According to an embodiment of the invention, the touch sensing structure is disposed between the second substrate and the second parallax electrode layer.

According to an embodiment of the invention, the touch sensing parallax integrated panel further includes a first insulation layer. The first insulation layer is disposed between the first parallax electrode layer and the first substrate.

According to an embodiment of the invention, the touch sensing parallax integrated panel further includes a metal circuit layer. The metal circuit layer is electrically connected to the first parallax electrode layer and located between the first insulation layer and the first substrate.

According to an embodiment of the invention, the first insulation layer has a first through hole. The first through hole exposes the metal circuit layer. Besides, the first through hole is filled with the first parallax electrode layer, and the first parallax electrode layer is electrically connected to the metal circuit layer.

According to an embodiment of the invention, the touch sensing parallax integrated panel further includes a second insulation layer. The second insulation layer is disposed between the second parallax electrode layer and the touch sensing structure.

According to an embodiment of the invention, the touch sensing parallax integrated panel further includes a first flexible printed circuit board (PCB). The first flexible PCB is disposed on the second substrate and electrically connected to the touch sensing structure, the first parallax electrode layer, and the second parallax electrode layer.

According to an embodiment of the invention, the touch sensing parallax integrated panel further includes a conductive adhesive. The conductive adhesive is located between the first parallax electrode layer and the second parallax electrode layer. One end of the conductive adhesive is electrically connected to the first parallax electrode layer, and the other end of the conductive adhesive is electrically connected to the second parallax electrode layer and the first flexible PCB.

According to an embodiment of the invention, the touch sensing parallax integrated panel further includes a first integrated driving chip. The first integrated driving chip drives the touch sensing structure, the first parallax electrode layer, and the second parallax electrode layer through the first flexible PCB.

According to an embodiment of the invention, the touch sensing parallax integrated panel further includes a first polarizer. The second substrate is located between the first polarizer and the touch sensing structure.

According to an embodiment of the invention, the second substrate is located between the touch sensing structure and the second parallax electrode layer.

According to an embodiment of the invention, the touch sensing 3D display device further includes a protection board. The touch sensing structure is located between the protection board and the second substrate.

According to an embodiment of the invention, the touch sensing parallax integrated panel further includes a second polarizer. The second polarizer is located between the protection board and the touch sensing structure.

According to an embodiment of the invention, the touch sensing 3D display device further includes a second flexible PCB and a third flexible PCB. The second flexible PCB is electrically connected to the touch sensing structure, and the third flexible PCB is electrically connected to the first parallax electrode layer and the second parallax electrode layer. The second flexible PCB has a first contact. The third flexible PCB has a second contact corresponding to the first contact. The first contact and the second contact are electrically connected to each other.

According to an embodiment of the invention, the touch sensing 3D display device further includes a second integrated driving chip. The second integrated driving chip is connected to the second flexible PCB. Besides, the second integrated driving chip drives the touch sensing structure through the second flexible PCB. In addition, the second integrated driving chip drives the first parallax electrode layer and the second parallax electrode layer through the first contact, the second contact, and the third flexible PCB.

According to an embodiment of the invention, the touch sensing structure includes a plurality of first sensing series electrically insulated from one another and a plurality of second sensing series electrically insulated from one another. The second sensing series and the first sensing series are alternately arranged, and the second sensing series are electrically insulated from the first sensing series.

According to an embodiment of the invention, the touch sensing structure further includes a plurality of insulation patterns. The insulation patterns are at least located at intersections of the first sensing series and the second sensing series.

According to an embodiment of the invention, the display medium layer includes a liquid crystal material layer or an organic electroluminescent layer.

Based on the above, in the touch sensing 3D display device described in an embodiment of the invention, the touch sensing functions and the 3D display functions may be integrated into one touch sensing parallax integrated panel, and an adhesion process is performed to adhere the touch sensing parallax integrated panel and the display panel, so as to implement the touch sensing 3D display device. Hence, in comparison with the conventional touch sensing 3D display device, the touch sensing 3D display device described in an embodiment of the invention is less likely to encounter errors caused by lack of adhesion precision and the number of adhesion processes. Thereby, the costs spent on the adhesion processes may also be reduced.

Other features and advantages of the invention will be further understood from the further technological features disclosed by the embodiments of the invention wherein there are shown and described embodiments of this invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic cross-sectional view illustrating a touch sensing 3D display device according to an embodiment of the invention.

FIG. 2 is a schematic cross-sectional view illustrating a touch sensing parallax integrated panel according to an embodiment of the invention.

FIG. 3 is a schematic cross-sectional view illustrating a touch sensing parallax integrated panel according to another embodiment of the invention.

FIG. 4 is a schematic cross-sectional view illustrating a touch sensing 3D display device according to another embodiment of the invention.

FIG. 5 is a schematic cross-sectional view illustrating a touch sensing parallax integrated panel according to still another embodiment of the invention.

### DESCRIPTION OF EMBODIMENTS

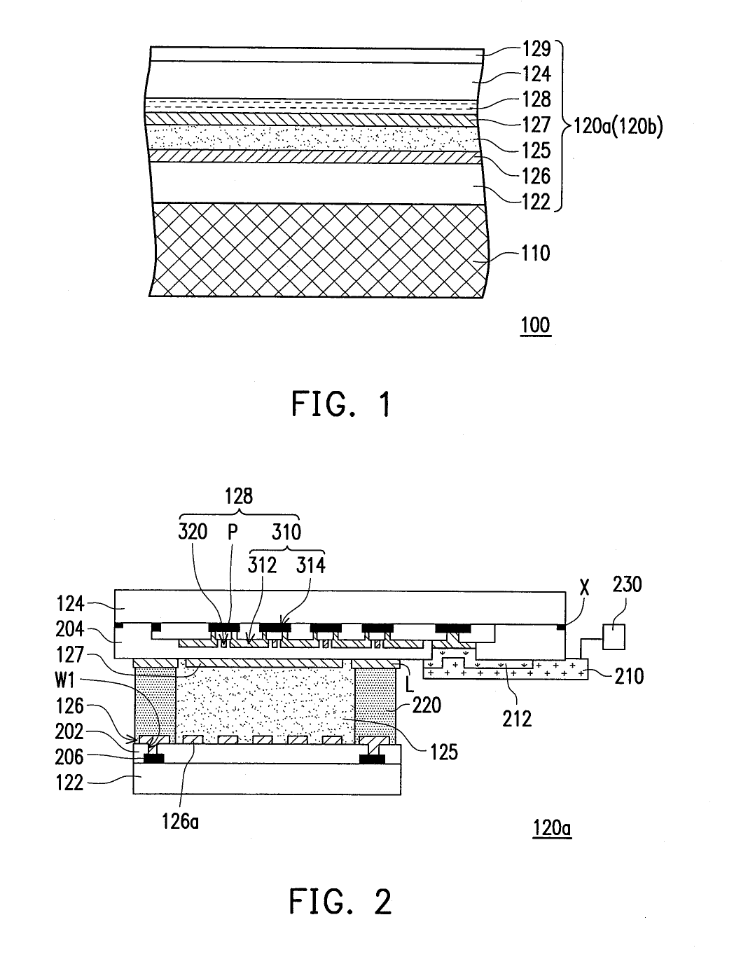

FIG. 1 is a schematic cross-sectional view illustrating a touch sensing 3D display device according to an embodiment of the invention. With reference to FIG. 1, the touch sensing 3D display device 100 includes a display panel 110 and a touch sensing parallax integrated panel 120a. The touch sensing parallax integrated panel 120a is disposed on the display panel 110. In the present embodiment, the display panel 110 is, for instance, a liquid crystal display (LCD) panel. However, the invention is not limited to the above, and the display panel 110 described in other embodiments of the invention may not only be an LCD panel but also be an organic electroluminescent display panel, an electrophoretic display panel, a plasma display panel, an electrowetting display panel, a field emission display panel, or any other appropriate display panel.

The touch sensing parallax integrated panel 120a includes a first substrate 122, a second substrate 124, a display medium layer 125, a first parallax electrode layer 126, a second parallax electrode layer 127, and a touch sensing structure 128. The second substrate 124 is disposed opposite to the first substrate 122. The first substrate 122 is located between the display panel 110 and the second substrate 124. In the present embodiment, the first substrate 122 and the second substrate 124 may be transparent substrates and may be made of glass, quartz, organic polymer, or any other suitable material.

The touch sensing structure 128 may be located on the second substrate 124. Here, the touch sensing structure 128 may provide a touch sensing function. The display medium layer 125 is disposed between the first substrate 122 and the second substrate 124. According to the present embodiment, the display medium layer 125 is, for instance, a liquid crystal material layer, an organic electroluminescent layer, or any other appropriate medium layer. The first parallax electrode layer 126 and the second parallax electrode layer 127 may be disposed on the first substrate 122 and the second substrate 124, respectively. Specifically, the first parallax electrode layer 126 may be disposed between the display medium layer 125 and the first substrate 122, and the second parallax electrode layer 127 may be disposed between the display medium layer 125 and the second substrate 128. Besides, the first parallax electrode layer 126 and the second parallax electrode layer 127 are preferably made of a transparent conductive material. Here, the transparent conductive material is, for instance, indium tin oxide (ITO), indium zinc oxide (IZO), aluminum tin oxide (ATO), aluminum zinc oxide (AZO), indium germanium zinc oxide (IGZO), any other appropriate oxide, or a stacked layer consisting of at least two of the above-mentioned materials.

The touch sensing parallax integrated panel 120a described herein may further include a first polarizer 129. The polarization light emitted from the display panel 110 described herein may pass or may be shielded by the first polarizer 129 of the touch sensing parallax integrated panel 120a, and thereby the 3D display function can be achieved. According to the present embodiment, the second substrate 124 is located between the first polarizer 129 and the touch sensing structure 128, which should however not be construed as a limitation to the invention. In another embodiment, the first polarizer 129 may be disposed between the second substrate 124 and the touch sensing structure 128 or at any other appropriate location.

To elaborate the relationship among film layers in the touch sensing parallax integrated panel 120a, the structure of the touch sensing parallax integrated panel 120a is described below with reference to FIG. 2. FIG. 2 is a schematic cross-sectional view illustrating a touch sensing parallax integrated panel according to an embodiment of the invention. In order to clearly show the structure of the touch sensing parallax integrated panel 120a described herein, the first polarizer 129 depicted in FIG. 1 is omitted in FIG. 2.

With reference to FIG. 2, a first insulation layer 202 and a metal circuit layer 206 may be selectively disposed in the touch sensing parallax integrated panel 120a according to the present embodiment, so as to reduce the resistance of the first parallax electrode layer 126. The first insulation layer 202 and the metal circuit layer 206 are located on the first substrate 122. In particular, the metal circuit layer 206 may be located between the first insulation layer 202 and the first substrate 122, and the first insulation layer 202 may be located between the first parallax electrode layer 126 and the first substrate 122. The first insulation layer 202 may have a first through hole W1. The first through hole W1 exposes the metal circuit layer 206. Besides, the first through hole W1 is filled with a portion of the first parallax electrode layer 126, such that the first parallax electrode layer 126 is electrically connected to the metal circuit layer 206. Through the metal circuit layer 206, the resistance of the first parallax electrode layer 126 may be reduced, and thereby the touch sensing parallax integated panel 120a described herein is more applicable to a large-size touch sensing 3D display device.

According to the present embodiment, the first parallax electrode layer 126 includes a plurality of bar-shaped electrodes 126a which are separated from and parallel to one another, and the second parallax electrode layer 127 may be a complete electrode layer covering the bar-shaped electrodes 126a. In the present embodiment, a method of displaying a stereo image is described below. Different voltages are respectively applied to the first parallax electrode layer 126 and the second parallax electrode layer 127, so as to control the rotation direction of the display media of the display medium layer 125. Thereby, one region of the display medium layer 125 covered by the bar-shaped electrodes 126a can have retardation. By contrast, the other region of the display medium layer 125 not covered by the bar-shaped electrodes 126a does not have retardation. When the polarization light emitted from the display panel 110 passes through the region of the display medium layer 125 covered by the bar-shaped electrodes 126a, the polarization state of the polarization light is changed, and the polarization light is then shielded by the first polarizer 129 (shown in FIG. 1). In contrast thereto, when the polarization light emitted from the display panel 110 passes through the region of the display medium layer 125 not covered by the bar-shaped electrodes 126a, the polarization state of the polarization light remains unchanged, and the polarization light can then pass the first polarizer 129. Namely, the touch sensing parallax integrated panel 120a described in the present embodiment is equivalent to a barrier. Through the barrier, the image displayed on the display panel 110 (shown in FIG. 1) may be respectively projected to the left and right eyes of a user, so as to achieve 3D display effects. Note that the method of displaying the stereo image provided in the disclosure is not limited to that described above.

With reference to FIG. 1 and FIG. 2, the touch sensing structure 128 of the touch sensing parallax integrated panel 120a described herein may be located between the second substrate 124 and the second parallax electrode layer 127. In the present embodiment, the touch sensing structure 128 includes a plurality of first sensing series 310 electrically insulated from one another, a plurality of second sensing series 320 electrically insulated from one another, and a plurality of insulation patterns P. The second sensing series 320 and the first sensing series 310 are alternately arranged, and the second sensing series 320 are electrically insulated from the first sensing series 310 through the insulation patterns P. Particularly, the first sensing series 310 include a plurality of first sensing pads 312 and a plurality of first bridge portions 314. Each of the first bridge portions 314 is connected to two adjacent first sensing pads 312. The insulation patterns P are at least located at intersections of the first sensing series 310 and the second sensing series 320. That is, the insulation patterns P may be located at the intersections of the first sensing series 310 and the second sensing series 320 and may also be disposed at other locations. In the present embodiment, the insulation patterns P may be located at the intersections of the second sensing series 320 and the first bridge portions 314 of the first sensing series 310 and also between two adjacent second sensing series 320. Note that the touch sensing parallax integrated panel 120a described herein not only can act as a parallax barrier but also can accomplish a touch sensing effect through the touch sensing structure 128 integrated into the touch sensing parallax integrated panel 120a. Hence, the exemplary structural design of the touch sensing structure 128 described above should not be construed as a limitation to the invention, and the touch sensing structure 128 in other embodiments may have other proper structural design.

In the present embodiment, the touch sensing parallax integrated panel 120a may include a second insulation layer 204. The second insulation layer 204 may be disposed between the second parallax electrode layer 127 and the touch sensing structure 128, such that the touch sensing structure 128 is electrically insulated from the second parallax electrode layer 127.

Besides, the touch sensing parallax integrated panel 120a described herein may further include a first flexible PCB, a conductive adhesive 220, and a first integrated driving chip 230. It should be mentioned that the function of driving the parallax electrode layers (including the first and second parallax electrode layers 126 and 127) and the function of driving the touch sensing structure 128 may be integrated into the same first integrated driving chip 230 in the touch sensing display device described in the present embodiment, so as to reduce the material costs of the driving chip.

In the present embodiment, the touch sensing structure 128 may be electrically connected to the first integrated driving chip 230 through contact pads 212 and circuits of the first flexible PCB 210. Thereby, the touch sensing structure 128 may be driven by the first integrated driving chip 230. The second parallax electrode layer 127 may be electrically connected to the first flexible PCB 210 through external traces L. After that, the second parallax electrode layer 127 may be electrically connected to the first integrated driving chip 230 through the first flexible PCB 210. The first parallax electrode layer 126 may be electrically connected to the external traces L on the second substrate 124 through a conductive adhesive 220. The external traces L are electrically connected to the first integrated driving chip 230. Hence, the first parallax electrode layer 126 may be electrically connected to the first integrated driving chip 230 through the conductive adhesive 220, the external traces L, and the first flexible PCB 210. As such, the parallax electrode layers (including the first parallax electrode layer 126 and the second parallax electrode layer 127) may be driven by the first integrated driving chip 230.

According to the related art, the integration of the display panel, the touch sensing panel, and the 3D display technology is accomplished by performing an adhesion process twice. By contrast, in the manufacturing process of the touch sensing 3D display device described in the present embodiment, the adhesion process is performed once to adhere the touch sensing parallax integrated panel and the display panel, so as to form the touch sensing 3D display device. Specifically, as indicated in FIG. 2, the touch sensing parallax integrated panel 120a and the display panel 110 are adhered to each other by assembling an alignment pattern X between the second substrate 124 and the second insulation layer 204 to another alignment pattern (not shown) that is located in the display panel 110 (shown in FIG. 1) and corresponds to the alignment pattern X. Namely, the touch sensing 3D display device described in the present embodiment of the invention is less likely to encounter errors caused by lack of adhesion precision and the number of adhesion processes. Moreover, the costs spent on the adhesion processes may also be reduced.

In the present embodiment, the touch sensing cell 128 is configured in the touch sensing parallax integrated panel (the touch sensing parallax integrated panel has an in-cell touch sensing structure). Since the touch sensing parallax integrated panel described herein is not formed by adhering individual touch sensing panel and 3D display panel, the number of photo masks, substrates, flexible PCBs, or integrated driving chips may be further reduced in the present embodiment, and the space occupied by the touch sensing parallax integrated panel can be reduced as well. Moreover, the decrease in the thickness of the touch sensing parallax integrated panel leads to the reduction of the overall thickness of the touch sensing 3D display device described herein, and thereby transmittance of the touch sensing 3D display device can then be improved.

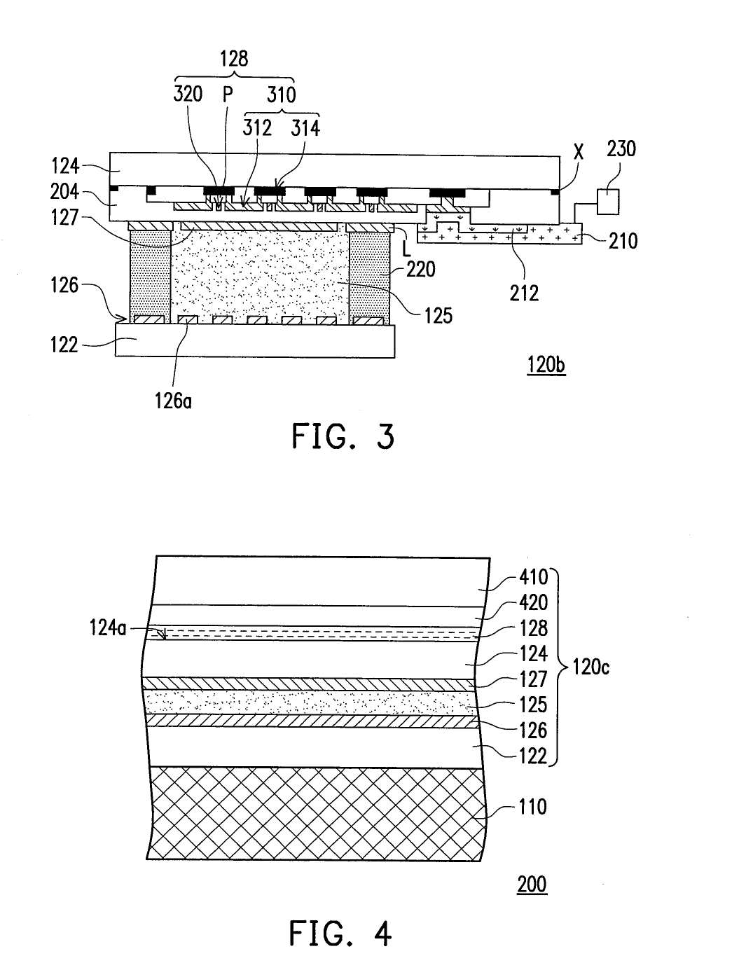

Besides, it is likely not to form the first insulation layer 202 and the metal circuit layer 206 on the first substrate 122 of the touch sensing parallax integrated panel 120a depicted in FIG. 2, so as to further reduce the number of photo masks required for forming the touch sensing 3D display device. FIG. 3 is a schematic cross-sectional view illustrating a touch sensing parallax integrated panel according to another embodiment of the invention. With reference to FIG. 2 and FIG. 3, in particular, the metal circuit layer 206 and the first through hole W1 of the first insulation layer 202 are formed by patterning an electrode layer (not shown) with use of a photo mask, for instance, so as to form the metal circuit layer 206. The first through hole W1 of the first insulation layer 202 is formed with use of another photo mask. Therefore, to form the two-layer structure (including the first through hole W1 of the first insulation layer 202 and the metal circuit layer 206) on the first substrate 122, two additional photo masks are required by the touch sensing parallel integrated panel 120a for patterning the two-layer structure. Nonetheless, as shown in FIG. 3 and described in the present embodiment, it is alternative not to form the two-layer structure on the first substrate 122 of the touch sensing parallax integrated panel 120b. Thus, the manufacturing costs on at least two photo masks may be further reduced in the touch sensing 3D display device that includes the touch sensing parallax integrated panel 120b. In the present embodiment, the touch sensing parallax integrated panel 120b is not equipped with the metal circuit layer, and therefore the first substrate 122 and the touch sensing parallax integrated panel 120b cannot be assembled by applying the alignment pattern formed on the metal circuit layer. However, in the present embodiment, the alignment pattern formed around the first parallax electrode layer 126 can also be applied to align and assemble the touch sensing parallax integrated panel 120b to the display panel 110. If the material of the first parallax electrode layer 126 is applied to form the circuit peripheral traces, the resistance is relatively large. Hence, in comparison with the touch sensing parallax integrated panel 120a applicable to the touch sensing 3D display devices in different sizes, the touch sensing parallax integrated panel 120b described in the present embodiment is more applicable to a small-size touch sensing 3D display device.

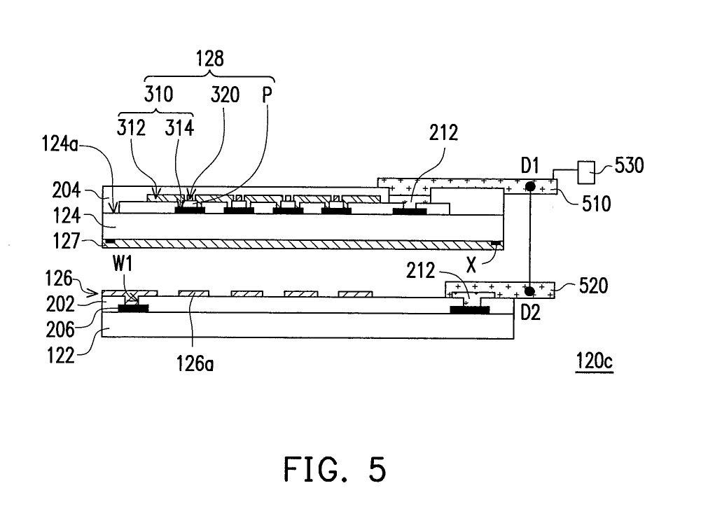

As described herein, the touch sensing parallax integrated panel not only can have an in-cell touch sensing structure but also can have the touch sensing structure configured on an outer surface of the second substrate. Explanations are exemplarily given below with reference to FIG. 4 and FIG. 5.

FIG. 4 is a schematic cross-sectional view illustrating a touch sensing 3D display device according to another embodiment of the invention. FIG. 5 is a schematic cross-sectional view illustrating a touch sensing parallax integrated panel depicted in FIG. 4. To clearly illustrate the structure of the touch sensing parallax integrated panel 120c, the protection board 410 and the second polarizer 420 depicted in FIG. 4 are omitted in FIG. 5.

With reference to FIG. 4 and FIG. 5, the touch sensing 3D display device 200 described in the present embodiment is similar to the touch sensing 3D display device 100 depicted in FIG. 1, and thus the same components are represented by identical reference numbers. The difference between the touch sensing 3D display device 200 and the touch sensing 3D display device 100 is that the touch sensing 3D display device 200 further includes a protection board 410. The location of the second polarizer 420 in the touch sensing 3D display device 200 is different from the location of the first polarizer 129 in the touch sensing 3D display device 100. Besides, the structure of the touch sensing parallax integrated panel 120c in the touch sensing 3D display device 200 is also distinct from the structure of the touch sensing parallax integrated panel 120b in the touch sensing 3D display device 100. Differences between the two touch sensing 3D display devices 100 and 200 are described hereafter, and similarities thereof are omitted.

With reference to FIG. 4, the touch sensing 3D display device 200 may further include a protection board 410. The touch sensing structure 128 may be located between the protection board 410 and the second substrate 124. The second polarizer 420 may be located between the protection board 410 and the touch sensing structure 128. In the present embodiment, the protection board 410 serves to protect the underlying components, and a material of the protection board 410 may be similar to the material of the first substrate 122 or the material of the second substrate 124 and thus will not be described herein.

With reference to FIG. 4 and FIG. 5, in the touch sensing 3D display device 200, the second substrate 124 may be located between the touch sensing structure 128 and the second parallax electrode layer 127. In other words, the touch sensing structure 128 may be located on an outer surface 124a of the second substrate 124. Additionally, as indicated in FIG. 5, the touch sensing 3D display device 200 further includes a second flexible PCB 510 and a third flexible PCB 520. The second flexible PCB 510 is electrically connected to the touch sensing structure 128, and the third flexible PCB 520 is electrically connected to the first parallax electrode layer 126 and the second parallax electrode layer 127. The second flexible PCB 510 has a first contact D1. The third flexible PCB 520 has a second contact D2 corresponding to the first contact D 1. The first contact D1 may be electrically connected to the second contact D2.

Besides, the touch sensing 3D display device 200 further includes a second integrated driving chip 530 connected to the third flexible PCB 520. The second integrated driving chip 530 may drive the touch sensing structure 128 through the third flexible PCB 520. In addition, the second integrated driving chip 530 may drive the first parallax electrode layer 126 and the second parallax electrode layer 127 through the first contact D1, the second contact D2, and the second flexible PCB 510. That is, in the touch sensing 3D display device 200, the number of the required driving chips and the material costs can also be reduced by electrically connecting the touch sensing structure 128 to each parallax electrode layer (including the first parallax electrode layer 126 and the second parallax electrode layer 127).

Similar to the manufacturing process of the touch sensing 3D display device 100, in the manufacturing process of the touch sensing 3D display device 200, the touch sensing parallax integrated panel 120c and the display panel 110 may be adhered in an adhesion process to reduce the errors caused by lack of adhesion precision and the number of adhesion processes. Particularly, the touch sensing parallax integrated panel 120c and the display panel 110 are adhered to each other by assembling an alignment pattern X between the second substrate 124 and the second parallax electrode layer 127 to another alignment pattern corresponding to the alignment pattern X.

From another perspective, in the touch sensing 3D display device 200, the first and second parallax electrode layers 126 and 127 and the touch sensing structure 128 are respectively located at two different sides of the second substrate 124. Accordingly, in the manufacturing process of the touch sensing 3D display device 200, the touch signals sensed by the touch sensing structure 128 are prone to be interfered by the signals that drive the first and second parallax electrode layers 126 and 127. Since the touch sensing 3D display devices 200 and 100 have similar effects and advantages, no further descriptions are provided hereinafter.

To sum up, in the touch sensing 3D display device described in an embodiment of the invention, the touch sensing functions and the 3D display functions may be integrated into one touch sensing parallax integrated panel, and an adhesion process is performed once to adhere the touch sensing parallax integrated panel and the display panel, so as to implement the touch sensing 3D display device. Hence, in comparison with the conventional touch sensing 3D display device, the touch sensing 3D display device described in an embodiment of the invention is less likely to encounter errors caused by lack of adhesion precision and the number of adhesion processes. Moreover, the costs spent on adhesion processes may also be reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch sensing three-dimensional display device comprising:
a display panel; and
a touch sensing parallax integrated panel disposed on the display panel, the touch sensing parallax integrated panel comprising:
a first substrate;
a second substrate opposite to the first substrate, the first substrate being located between the display panel and the second substrate;
a touch sensing structure disposed on the second substrate;
a display medium layer disposed between the first substrate and the second substrate;
a first parallax electrode layer disposed on the first substrate and located between the display medium layer and the first substrate; and
a second parallax electrode layer disposed on the second substrate and disposed between the display medium layer and the second substrate.

2. The touch sensing three-dimensional display device as recited in claim 1, wherein the first parallax electrode layer comprises a plurality of bar-shaped electrodes, the bar-shaped electrodes are separated from and parallel to one another, and the second parallax electrode layer comprises a complete electrode layer covering the bar-shaped electrodes.

3. The touch sensing three-dimensional display device as recited in claim 1, wherein the touch sensing structure is disposed between the second substrate and the second parallax electrode layer.

4. The touch sensing three-dimensional display device as recited in claim 1, wherein the touch sensing parallax integrated panel further comprises a first insulation layer disposed between the first parallax electrode layer and the first substrate.

5. The touch sensing three-dimensional display device as recited in claim 4, wherein the touch sensing parallax integrated panel further comprises a metal circuit layer, and the metal circuit layer is electrically connected to the first parallax electrode layer and located between the first insulation layer and the first substrate.

6. The touch sensing three-dimensional display device as recited in claim 5, wherein the first insulation layer has a first through hole exposing the metal circuit layer, the first through hole is filled with the first parallax electrode layer, and the first parallax electrode layer is electrically connected to the metal circuit layer.

7. The touch sensing three-dimensional display device as recited in claim 3, wherein the touch sensing parallax integrated panel further comprises a second insulation layer disposed between the second parallax electrode layer and the touch sensing structure.

8. The touch sensing three-dimensional display device as recited in claim 3, wherein the touch sensing parallax integrated panel further comprises a first flexible printed circuit board, and the first flexible printed circuit board is disposed on the second substrate and electrically connected to the touch sensing structure, the first parallax electrode layer, and the second parallax electrode layer.

9. The touch sensing three-dimensional display device as recited in claim 8, wherein the touch sensing parallax integrated panel further comprises a conductive adhesive located between the first parallax electrode layer and the second parallax electrode layer, one end of the conductive adhesive is electrically connected to the first parallax electrode layer, and the other end of the conductive adhesive is electrically connected to the second parallax electrode layer and the first flexible printed circuit board.

10. The touch sensing three-dimensional display device as recited in claim 8, wherein the touch sensing parallax integrated panel further comprises a first integrated driving chip, and the first integrated driving chip drives the touch sensing structure, the first parallax electrode layer, and the second parallax electrode layer through the first flexible printed circuit board.

11. The touch sensing three-dimensional display device as recited in claim 3, wherein the touch sensing parallax integrated panel further comprises a first polarizer, and the second substrate is located between the first polarizer and the touch sensing structure.

12. The touch sensing three-dimensional display device as recited in claim 1, wherein the second substrate is located between the touch sensing structure and the second parallax electrode layer.

13. The touch sensing three-dimensional display device as recited in claim 12, further comprising a protection board, the touch sensing structure being located between the protection board and the second substrate.

14. The touch sensing three-dimensional display device as recited in claim 13, wherein the touch sensing parallax integrated panel further comprises a second polarizer, and the second polarizer is located between the protection board and the touch sensing structure.

15. The touch sensing three-dimensional display device as recited in claim 12, further comprising a second flexible printed circuit board and a third flexible printed circuit board, the second flexible printed circuit board being electrically connected to the touch sensing structure, the third flexible printed circuit board being electrically connected to the first parallax electrode layer and the second parallax electrode layer, wherein the second flexible printed circuit board has a first contact, the third flexible printed circuit board has a second contact corresponding to the first contact, and the first contact and the second contact are electrically connected to each other.

16. The touch sensing three-dimensional display device as recited in claim 15, further comprising a second integrated driving chip connected to the second flexible printed circuit board, the second integrated driving chip driving the touch sensing structure through the second flexible printed circuit board and driving the first parallax electrode layer and the second parallax electrode layer through the first contact, the second contact, and the third flexible printed circuit board.

17. The touch sensing three-dimensional display device as recited in claim 1, wherein the touch sensing structure comprises a plurality of first sensing series electrically insulated from one another and a plurality of second sensing series electrically insulated from one another, the second sensing series and the first sensing series are alternately arranged, and the second sensing series are electrically insulated from the first sensing series.

18. The touch sensing three-dimensional display device as recited in claim 17, wherein the touch sensing structure further comprises a plurality of insulation patterns at least located at intersections of the first sensing series and the second sensing series.

19. The touch sensing three-dimensional display device as recited in claim 1, wherein the display medium layer comprises a liquid crystal material layer or an organic electroluminescent layer.
